(19) United States
(12) Patent Application Publication
(10) Pub. No.: US 2011/0200092 A1
(43) Pub. Date: Aug. 18, 2011

(54) DIGITIAL BROADCAST RECEIVER

(76) Inventors: Yoshio Todoroki, Tokyo (JP); Nobuyoshi Okumura, Tokyo (JP); Kazuma Kaneko, Tokyo (JP)

(21) Appl. No.: 12/673,470

(22) PCT Filed: Jun. 2, 2008
(86) PCT No.: PCT/JP2008/001388

§ 371 Date: Feb. 12, 2010

(30) Foreign Application Priority Data
Nov. 12, 2007 (JP) 2007-293050

(51) Int. Cl. H04N 11/02; H04L 27/00

(52) U.S. Cl. 375/240.01; 375/316; 375/E07.026

(57) ABSTRACT

A digital broadcast receiver includes a subtitle monitoring unit 21 for continuously monitoring as to whether a received signal obtained by receiving a digital broadcast contains subtitles or not; a subtitle analyzing unit 22 for analyzing, when the monitoring detects that the subtitles are contained, the subtitles to generate subtitle information; an external image input unit 11 for receiving an external image from outside; a video layout unit 24 for deciding, as to the external image and a subtitle presenting image generated from the subtitle information, display size and display position of each of the subtitle presenting image and the external image in such a manner as to avoid overlaps between them; a graphics creating unit 23 for creating from the subtitle information the subtitle presenting image conforming to the decision made by the video layout unit; and a video synthesizing unit 23 for combining the subtitle presenting image created and the external image, and displays a synthesized image.

### TECHNICAL FIELD

The present invention relates to a digital broadcast receiver, and more particularly to a technique of displaying subtitles in cooperation with external equipment such as a car navigation system connected externally.

### BACKGROUND ART

While viewing a television broadcast, there are some cases when disaster information such as that about a tsunami or earthquake or other spot news are displayed on the screen. Although such information has high importance and great urgency, it is information that can be obtained only when viewing a television broadcast. Thus, there is a problem of being unable to obtain it in other cases.

As a technique to solve such a problem, Patent Document 1 discloses a digital broadcast receiving apparatus capable of monitoring subtitles of digital broadcasting even while a user is viewing a medium other than the digital broadcasting, and notifying the user of flash information.

The digital broadcast receiving apparatus includes a subtitle monitoring unit for continuously monitoring subtitles of a digital broadcast, a video output unit capable of outputting the received subtitles by superimposing on an image currently viewed, an audio output unit capable of outputting the subtitles in voice, and an OSD output unit for displaying the subtitles on an OSD (on-screen display), in which the subtitle monitoring unit monitors the subtitles of the digital broadcast even when the user is viewing a medium other than the digital broadcast, and notifies the user, when the subtitles are broadcast by the digital broadcast, by superimposing the subtitles on the image currently viewed, or via the OSD display or by voice.
Patent Document 1: Japanese Patent Laid-Open No. 2005-341200.

However, the digital broadcast receiving apparatus disclosed in the foregoing Patent Document 1 has a problem in that when the image currently viewed is a map of the car navigation system, for example, a display indicating place-names and a route becomes hard to see because of the subtitles that are superimposed or OSD displayed.

The present invention is implemented to solve the foregoing problem. Therefore it is an object of the present invention to provide a digital broadcast receiver capable of displaying the subtitles without any adverse effect on the image currently viewed.

### DISCLOSURE OF THE INVENTION

To solve the foregoing problem, the digital broadcast receiver in accordance with the present invention includes: receiving means for receiving a digital broadcast; a subtitle monitoring unit for continuously monitoring as to whether a received signal from the receiving means contains subtitles or not; a subtitle analyzing unit for analyzing, when the subtitle monitoring unit detects that the subtitles are contained, the subtitles to generate subtitle information; an external image input unit for receiving an external image from outside; a video layout unit for deciding, as to a subtitle presenting image generated from the subtitle information from the subtitle analyzing unit and the external image from the external image input unit, display size and display position of each of the subtitle presenting image and the external image in a manner as to avoid overlaps between them; a graphics creating unit for creating from the subtitle information from the subtitle analyzing unit the subtitle presenting image with the display size and display position decided by the video layout unit; a video synthesizing unit for combining the subtitle presenting image created by the graphics creating unit and the external image from the external image input unit; and display means for displaying an image synthesized by the video synthesizing unit.

According to a digital broadcast receiver in accordance with the present invention, since it is configured in such a manner that while the display means displays the external image from outside, it obtains the subtitle information from the received signal acquired by receiving a digital broadcast in the background, creates the subtitle presenting image, and displays the external image and the subtitle presenting image after combining them in such a manner as to avoid overlaps between them, a user can watch the subtitles without switching the image currently viewing to the digital broadcast, and avoid interference with his or her viewing.

### BRIEF DESCRIPTION OF THE DRAWINGS

FIG. 1 is a block diagram showing a configuration of a digital broadcast receiver of an embodiment 1 in accordance with the present invention;

FIG. 2 is a block diagram showing a functional configuration of a CPU constituting the digital broadcast receiver of the embodiment 1 in accordance with the present invention;

FIG. 3 is a diagram showing an example of subtitle information generated by the digital broadcast receiver of the embodiment 1 in accordance with the present invention;

FIG. 4 is a diagram showing an example of a subtitle presenting image created by the digital broadcast receiver of the embodiment 1 in accordance with the present invention;

FIG. 5 is a diagram showing an example of a digital broadcast image created by the digital broadcast receiver of the embodiment 1 in accordance with the present invention;

FIG. 6 is a diagram showing an example of a car navigation image (map) created by the digital broadcast receiver of the embodiment 1 in accordance with the present invention;

FIG. 7 is a diagram showing an example of an image displayed on the monitor of the digital broadcast receiver of the embodiment 1 in accordance with the present invention;

FIG. 8 is a block diagram showing a configuration of a digital broadcast receiver of an embodiment 2 in accordance with the present invention;

FIG. 9 is a block diagram showing a functional configuration of the CPU constituting the digital broadcast receiver of the embodiment 2 in accordance with the present invention;

FIG. 10 is a diagram showing an example of a subtitle-related map created by the digital broadcast receiver of the embodiment 2 in accordance with the present invention;

FIG. 11 is a diagram showing an example of an image displayed on the monitor of the digital broadcast receiver of the embodiment 2 in accordance with the present invention;

FIG. 12 is a block diagram showing a configuration of a digital broadcast receiver of an embodiment 3 in accordance with the present invention;

FIG. 13 is a block diagram showing a functional configuration of the CPU constituting the digital broadcast receiver of the embodiment 3 in accordance with the present invention; and

FIG. 14 is a diagram showing an example of an image displayed on the monitor in the digital broadcast receiver of a second variation of the embodiment 3 in accordance with the present invention.

### BEST MODE FOR CARRYING OUT THE INVENTION

The best mode for carrying out the invention will now be described with reference to the accompanying drawings to explain the present invention in more detail.

### Embodiment 1

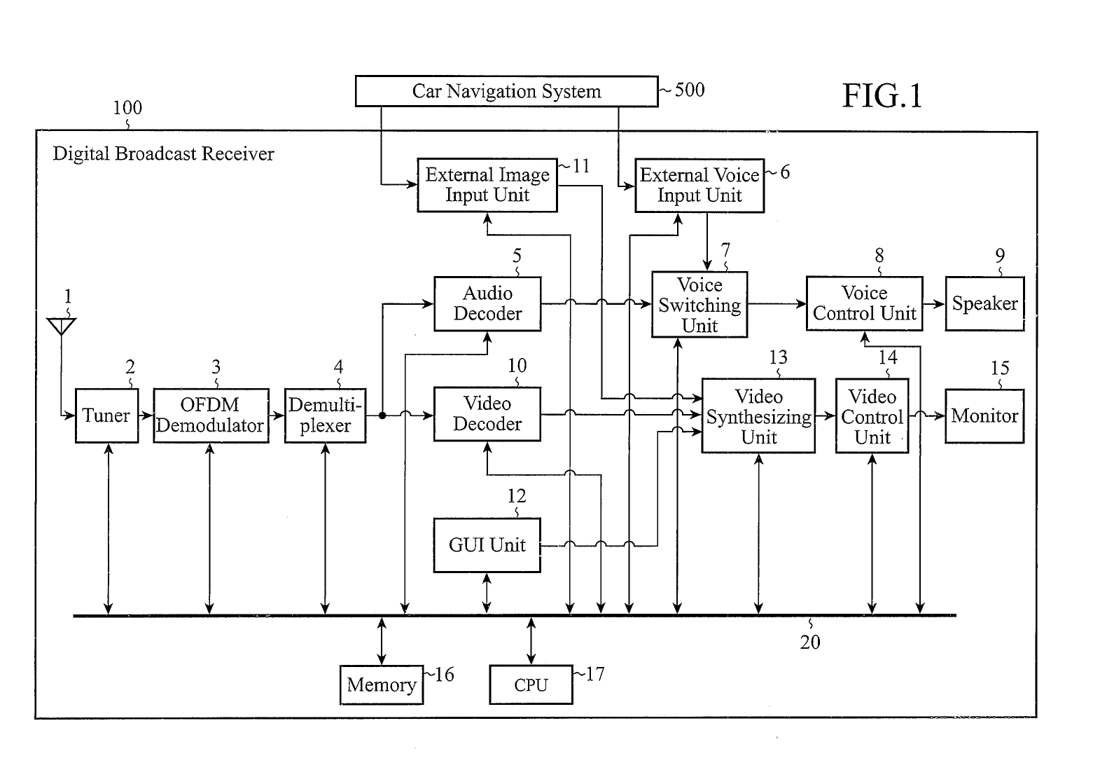

FIG. 1 is a block diagram showing a configuration of a digital broadcast receiver 100 of an embodiment 1 in accordance with the present invention. To the digital broadcast receiver 100, a car navigation system 500 is connected. Incidentally, a concept of the digital broadcast receiver in accordance with the present invention contains the car navigation system 500.

The car navigation system 500, which corresponds to external equipment in accordance with the present invention, delivers to the digital broadcast receiver 100 the car navigation video data far displaying a map or various images generated internally and the car navigation audio data for outputting a voice. The car navigation image created from the car navigation video data corresponds to an external image in accordance with the present invention.

The digital broadcast receiver 100 receives a digital broadcast, and reproduces images and voices. The digital broadcast receiver 100 has an antenna 1, a tuner 2, an OFDM (Orthogonal Frequency Division Multiplexing) demodulator 3, a demultiplexer 4, an audio decoder 5, an external voice input unit 6, a voice switching unit 7, a voice control unit 8, a speaker 9, a video decoder 10, an external image input unit 11, a GUI (Graphical User Interface) unit 12, a video synthesizing unit 13, a video control unit 14, a monitor 15, a memory 16, CPU 17 and a bus 20.

Among these components, the tuner 2, OFDM demodulator 3, demultiplexer 4, audio decoder 5, external voice input unit 6, voice switching unit 7, voice control unit 8, video decoder 10, external image input unit 11, GUI unit 12, video synthesizing unit 13, video control unit 14 and memory 16 are connected to the CPU 17 via the bus 20 and operate under the control of the CPU 17. The bus 20 transmits and receives the control signal and data between the individual components.

The antenna 1 receives radio waves of the digital broadcasting, converts them to electric signals, and delivers them to the tuner 2. The tuner 2 extracts the frequency component of the channel to be selected, which is designated by the CPU 17, from the signals delivered from the antenna 1, and delivers it to the OFDM demodulator 3. The OFDM demodulator 3 carries out OFDM demodulation of the signal delivered from the tuner 2 and then converts it to a digital signal, and delivers it to the demultiplexer 4 as a transport stream.

The demultiplexer 4 separates the transport stream delivered from the OFDM demodulator 3 to the audio stream, video stream and carousel, and delivers to the audio decoder 5, video decoder 10 and CPU 17 as a received signal, respectively. The receiving means in accordance with the present invention comprises the antenna 1, tuner 2, OFDM demodulator 3 and demultiplexer 4.

The audio decoder 5 decodes the audio stream delivered from the demultiplexer 4, and delivers to the voice switching unit 7 as digital broadcasting audio data. The external voice input unit 6 receives the car navigation audio data delivered from the car navigation system 500, and delivers to the voice switching unit 7.

The voice switching unit 7 selects the digital broadcasting audio data delivered from the audio decoder 5 or the car navigation audio data delivered from the external voice input unit 6, and delivers to the voice control unit 8 as the output audio data. The voice control unit 8 converts the output audio data delivered from the voice switching unit 7 to an analog voice signal, and delivers to the speaker 9. The speaker 9 produces the voice corresponding to the voice signal delivered from the voice control unit 8.

The video decoder 10 decodes the video stream delivered from the demultiplexer 4, and delivers to the video synthesizing unit 13 as the digital broadcasting video data. FIG. 5 is a diagram showing an example of a digital broadcast image created from the digital broadcasting video data.

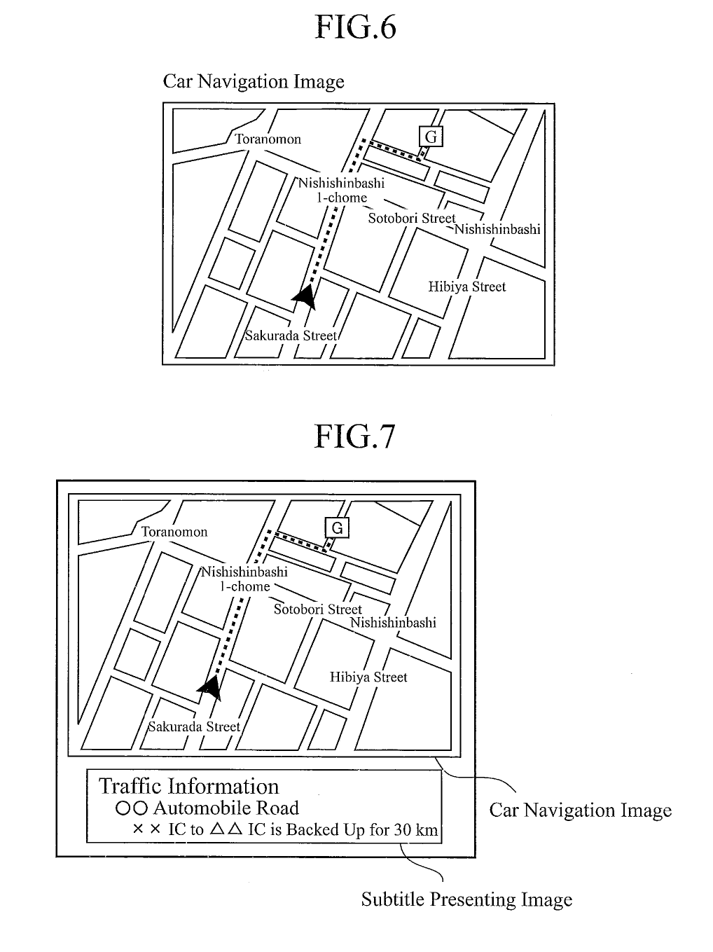

The external image input unit 11 receives the car navigation video data delivered from the car navigation system 500, and delivers to the video synthesizing unit 13. FIG. 6 is a diagram showing an example of a car navigation image (map) created from the car navigation video data.

The GUI unit 12 creates a menu screen. The menu screen data showing the menu screen created by the GUI unit 12 is delivered to the video synthesizing unit 13. In addition, the GUI unit 12 receives the signal from a remote control (not shown) operated by the user, and delivers to the CPU 17. According to the signal from the GUI unit 12, the CPU 17 executes various processing in accordance with the user operation.

According to the layout information delivered from the CPU 17 (its details will be described later), the video synthesizing unit 13 combines the digital broadcasting video data delivered from the video decoder 10, the car navigation video data delivered from the external image input unit 11, the menu screen data delivered from the GUI unit 12 and the subtitle presenting image data delivered from the CPU 17 (its details will be described later), and delivers to the video control unit 14 as the output video data.

The video control unit 14 converts the output video data delivered from the video synthesizing unit 13 to the analog video signal, and delivers to the monitor 15. The monitor 15 consists of an LCD (Liquid Crystal Display), for example, and displays an image corresponding to the video signal delivered from the video control unit 14. A display means in accordance with the present invention consists of the video control unit 14 and the monitor 15.

The memory 16, which is mainly used as a working memory of the CPU 17, stores various data temporarily. The CPU 17 interprets the signal from the GUI unit 12 as described above, and controls the tuner 2, OFDM demodulator 3, demultiplexer 4, audio decoder 5, external voice input unit 6, voice switching unit 7, voice control unit 8, video decoder 10, external image input unit 11, GUI unit 12, video synthesizing unit 13, video control unit 14 and memory 16, thereby controlling the whole operation of the digital broadcast receiver 100.

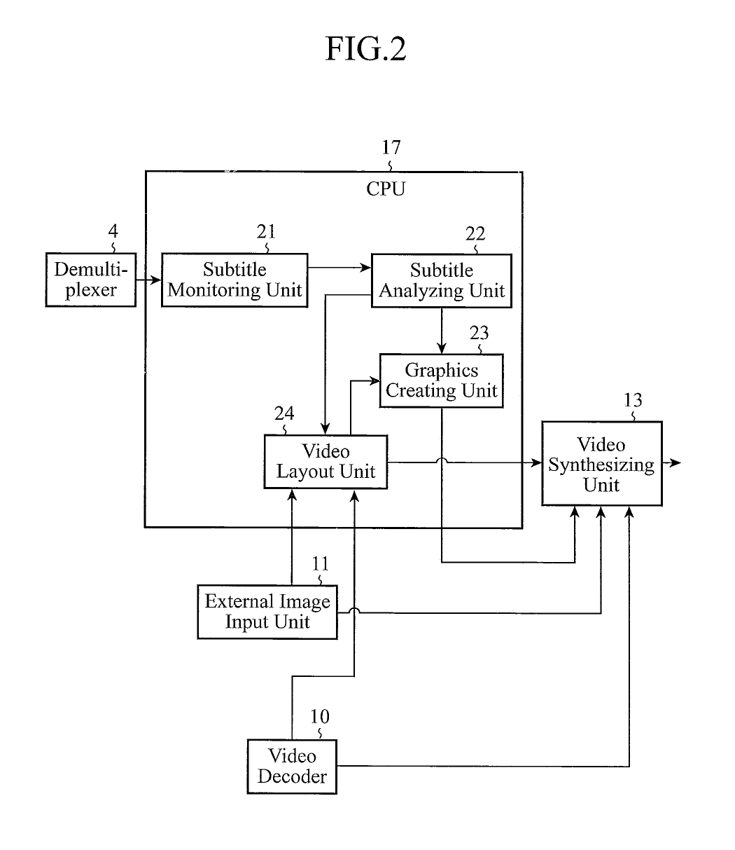

Next, details of the CPU 17 will be described. FIG. 2 is a block diagram showing a functional configuration of the CPU 17, which shows a portion only relating to the present invention. The CPU 17 includes a subtitle monitoring unit 21, a subtitle analyzing unit 22, a graphics creating unit 23 and a video layout unit 24, which are composed of programs.

The subtitle monitoring unit 21 receives the carousel delivered from the demultiplexer 4, and monitors continuously (even during the time when the digital broadcasting is not viewed) as to whether the carousel contains the subtitles or not, that is, whether the subtitles are received or not. Then, when it detects any subtitles contained, it delivers the carousel containing the subtitles to the subtitle analyzing unit 22.

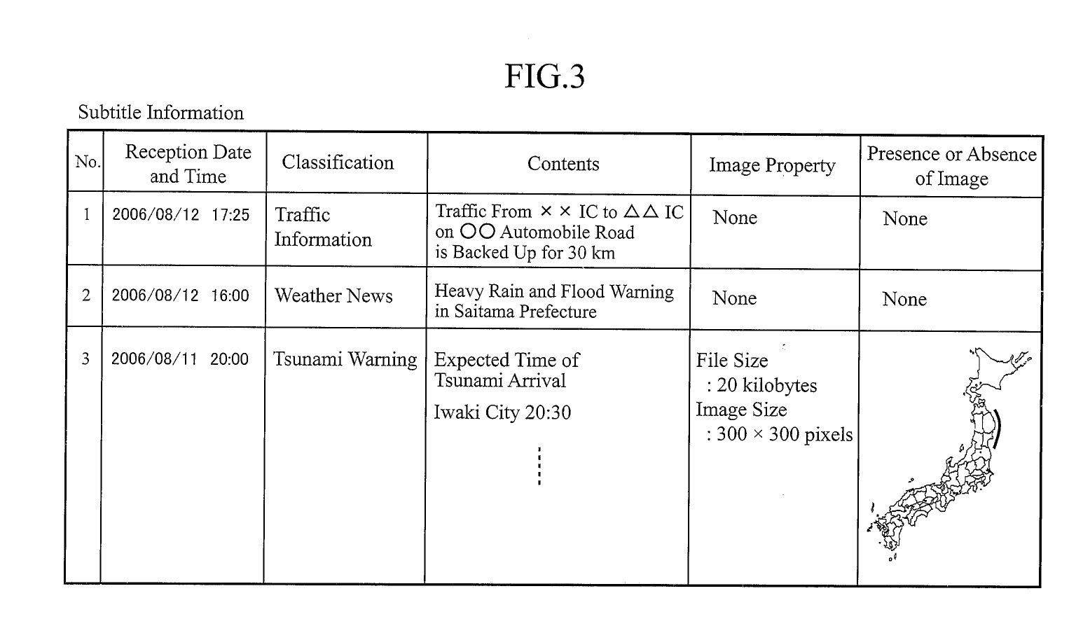

The subtitle analyzing unit 22 carries out analysis and extraction of the subtitles contained in the carousel delivered from the subtitle monitoring unit 21, and creates subtitle information containing the contents of the subtitles and detailed information on an image. FIG. 3 shows an example of the subtitle information. The subtitle information includes “reception date and time”, “classification”, “contents”, “image property” and “presence or absence of an image”. The subtitle information created by the subtitle analyzing unit 22 is delivered to the graphics creating unit 23 and video layout unit 24.

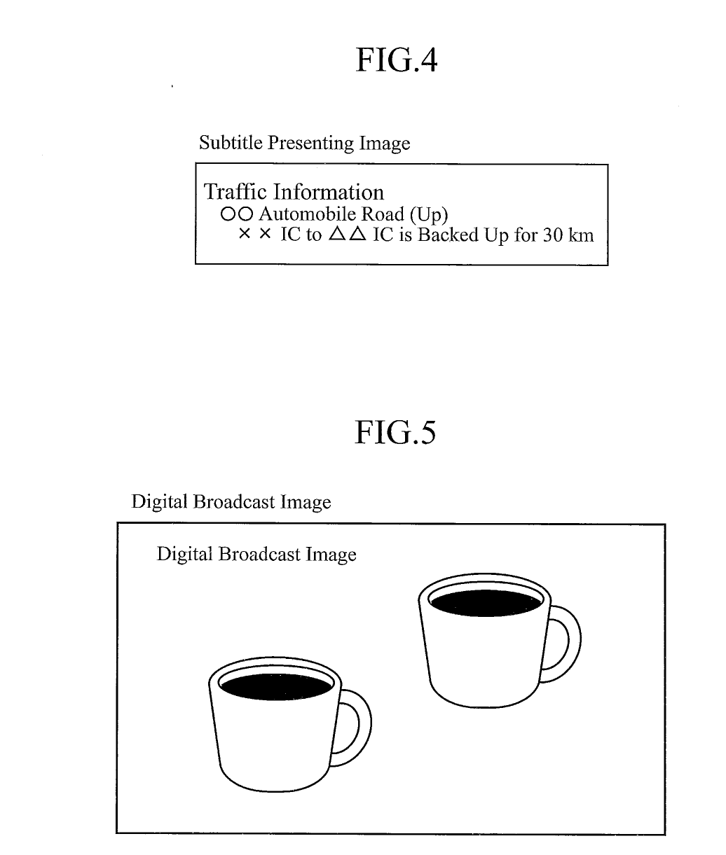

The graphics creating unit 23 produces a subtitle presenting image, which is to be displayed as the subtitles, from the subtitle information delivered from the subtitle analyzing unit 22, and from the layout information delivered from the video layout unit 24 (its detailed will be described later). FIG. 4 shows an example of the subtitle presenting image created from the No. 1 information in the subtitle information shown in FIG. 3. The subtitle presenting image data representing the subtitle presenting image created by the graphics creating unit 23 is delivered to the video synthesizing unit 13.

According to the size of the monitor 15, the subtitle information delivered from the subtitle analyzing unit 22 and the car navigation video data delivered from the external image input unit 11, the video layout unit 24 decides the display size and display position of the subtitle presenting image and the display size and display position of the car navigation image in such a manner as to avoid overlaps between the subtitle presenting image and the car navigation image, and outputs as the layout information. The layout information output from the video layout unit 24 is delivered to the graphics creating unit 23 and video synthesizing unit 13.

Next, the operation will be described in the case where the subtitles are received while viewing a digital broadcast on the digital broadcast receiver 100 of the embodiment 1 in accordance with the present invention with the foregoing configuration.

The radio waves of the digital broadcasts received with the antenna 1 are converted to an electric signal and is delivered to the tuner 2. The tuner 2 extracts from the signal delivered from the antenna 1 the frequency component of a channel to be selected according to the instruction of the CPU 17, and delivers to the OFDM demodulator 3. The OFDM demodulator 3 performs the OFDM demodulation on the signal delivered from the tuner 2, followed by converting to the digital signal, and delivers it to the demultiplexer 4 as the transport stream. The demultiplexer 4 separates the transport stream delivered from the OFDM demodulator 3 to the audio stream, video stream and carousel, and delivers to the audio decoder 5, video decoder 10 and CPU 17, respectively.

The carousel separated by the demultiplexer 4 is delivered to the subtitle monitoring unit 21 of the CPU 17. The subtitle monitoring unit 21 continuously monitors the presence or absence of the subtitles, and delivers, when detecting the reception of the subtitles, the carousel containing the subtitles to the subtitle analyzing unit 22. The subtitle analyzing unit 22 performs the analysis and extraction of the subtitles contained in the carousel received from the subtitle monitoring unit 21, and creates the subtitle information. The subtitle information created by the subtitle analyzing unit 22 is delivered to the graphics creating unit 23.

The graphics creating unit 23 creates the subtitle presenting image from the subtitle information delivered from the subtitle analyzing unit 22, and delivers to the video synthesizing unit 13 as the subtitle presenting image data. The video synthesizing unit 13 combines the subtitle presenting image data delivered from the graphics creating unit 23 and the digital broadcasting video data delivered from the video decoder 10. The output video data obtained by combining them by the video synthesizing unit 13 is delivered to the video control unit 14. The video control unit 14 converts the output video data delivered from the video synthesizing unit 13 to the analog video signal, and delivers to the monitor 15. The monitor 15 displays an image corresponding to the video signal delivered from the video control unit 14.

Incidentally, a configuration is also possible which stores the subtitle information created by the subtitle monitoring unit 21 in the memory 16, and refers to the information as needed as the history of the subtitles afterward.

Next, the operation will be described in the case where the digital broadcast receiver 100 of the embodiment 1 receives the subtitles while viewing the car navigation image and listening to the car navigation voice from the car navigation system 500. In this case, although the car navigation image is displayed on the monitor 15, the processing such as receiving, demultiplexing and decoding of a digital broadcast is carried out in parallel in the background.

As for the operations of receiving the digital broadcasting with the antenna 1, of separating to the audio stream, video stream and carousel by the demultiplexer 4, and of delivering to the audio decoder 5, video decoder 10 and CPU 17, they are the same as those when the subtitles are received while viewing the digital broadcast as described above.

The carousel separated by the demultiplexer 4 is delivered to the subtitle monitoring unit 21 of the CPU 17. The subtitle monitoring unit 21, which continuously monitors the presence or absence of the reception of the subtitles, delivers, when detecting the reception of the subtitles, the carousel containing the subtitles to the subtitle analyzing unit 22. The subtitle analyzing unit 22 performs the analysis and extraction of the subtitles contained in the carousel received from the subtitle monitoring unit 21 and creates the subtitle information. The subtitle information created by the subtitle analyzing unit is delivered to the video layout unit 24.

The video layout unit 24 decides the display size and display position of the subtitle presenting image and the display size and display position of the car navigation image in such a manner as to avoid overlaps between the subtitle presenting image and the car navigation image, and delivers to the graphics creating unit 23 and video synthesizing unit 13 as the layout information.

According to the display size indicated by the layout information delivered from the video layout unit 24, the graphics creating unit 23 creates the subtitle presenting image from the subtitle information delivered from the subtitle analyzing unit 22, and delivers to the video synthesizing unit 13. The video synthesizing unit 13 combines the subtitle presenting image delivered from the graphics creating unit 23 and the digital broadcast image delivered from the video decoder 10 in such a manner as to fulfill the display size and display position indicated by the layout information delivered from the video layout unit 24. The output video data combined by the video synthesizing unit is delivered to the video control unit 14.

The operation thereafter is the same as that when receiving the subtitles while viewing the digital broadcast as described above. FIG. 7 is a diagram showing an example of an image displayed on the monitor 15 by the foregoing processing, in which the car navigation image is reduced in the vertical direction and the subtitle presenting image is placed and displayed thereunder in such a manner as to avoid overlapping.

As described above, according to the digital broadcast receiver 100 of the embodiment 1 in accordance with the present invention, since it is configured in such a manner as to combine an image other than the digital broadcasting, that is, the subtitles received while the car navigation image is displayed on the monitor 15, with the car navigation image, and to display the synthesized image, the user can obtain the subtitle information even during the time when viewing the an image other than the digital broadcasting.

Incidentally, when the car navigation image is output, the voice switching unit 7 is preferably switched to the position for selecting the car navigation audio data delivered from the car navigation system 500 via the external voice input unit 6.

### Embodiment 2

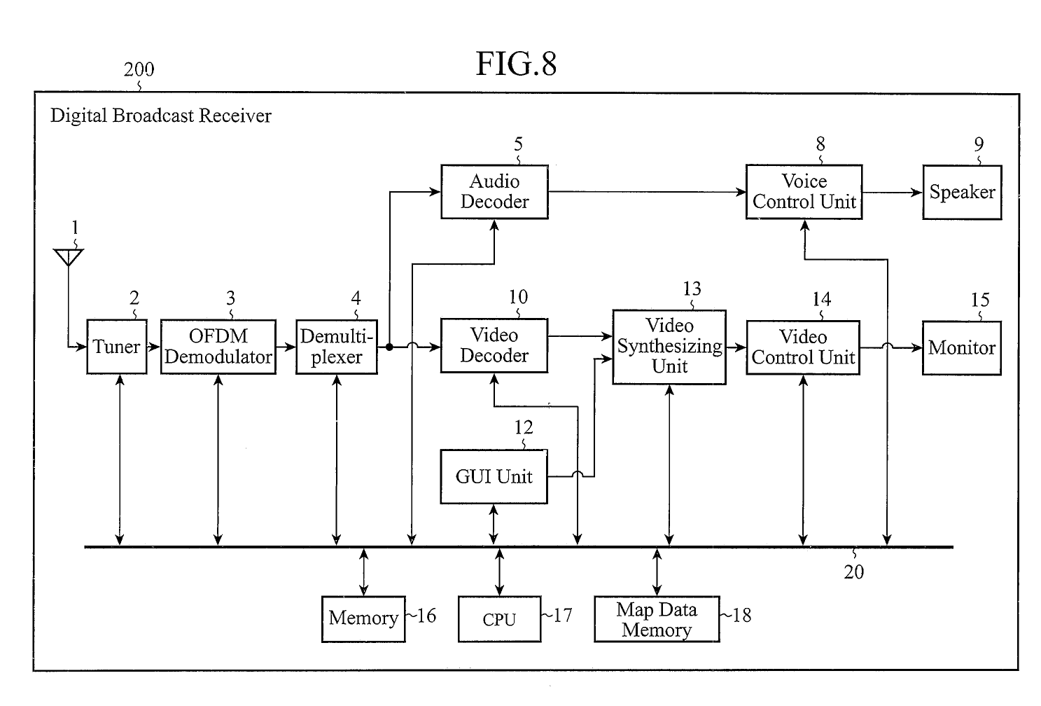

FIG. 8 is a block diagram showing a configuration of a digital broadcast receiver 200 of an embodiment 2 in accordance with the present invention. The digital broadcast receiver 200 is constructed by removing the external voice input unit 6, voice switching unit 7 and external image input unit 11 from the digital broadcast receiver 100 of the embodiment 1, by altering the output of the audio decoder 5 in such a manner as to be directly delivered to the voice control unit 8, and by adding a map data memory 18.

In the digital broadcast receiver 200 of the embodiment 2, the video synthesizing unit 13 generates the output video data by combining the digital broadcast image delivered from the video decoder 10, the menu screen delivered from the GUI unit 12, the subtitle presenting image delivered from the CPU 17 and the subtitle-related map delivered from the CPU 17 (its details will be described later), and delivers to the video control unit 14.

In this case, by introducing the function similar to that of the video layout unit 24 included in the CPU 17 of the digital broadcast receiver 100 of the embodiment 1, the video synthesizing unit 13 can be constructed in a way that it combines the digital broadcast image created by the video decoder 10, the subtitle presenting image created by the graphics creating unit 23 and the subtitle-related map created by a related-map creating unit 26 in such a manner as to avoid overlaps between them by adjusting the display size and display position of each of them. Thus, according to the configuration, it becomes possible to arrange the images in such a manner as to avoid interference with each other on the display.

The map data memory 18 stores map data. The map data stored in the map data memory 18 is read out by the related-map creating unit 26.

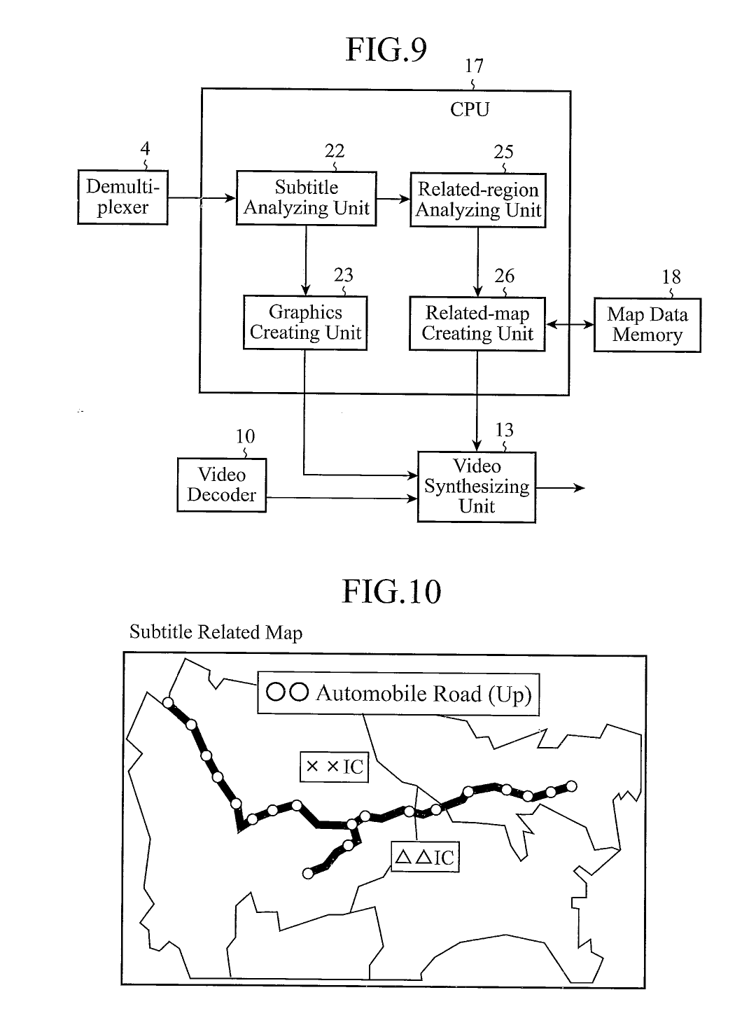

Next, details of the CPU 17 will be described. FIG. 9 is a block diagram showing a functional configuration of the CPU 17, which shows only a portion relating to the present invention. The CPU 17 comprises the subtitle analyzing unit 22, the graphics creating unit 23, a related-region analyzing unit 25 and the related-map creating unit 26.

The subtitle analyzing unit 22 performs analysis and extraction of the subtitles contained in the carousel delivered from the demultiplexer 4, and generates the subtitle information as shown in FIG. 3, for example. The subtitle information generated by the subtitle analyzing unit 22 is delivered to the graphics creating unit 23 and related-region analyzing unit 25.

The graphics creating unit 23 creates a subtitle presenting image as shown in FIG. 4, for example, from the subtitle information delivered from the subtitle analyzing unit 22. The subtitle presenting image data representing the subtitle presenting image created by the graphics creating unit 23 is delivered to the video synthesizing unit 13.

The related-region analyzing unit 25 analyzes the subtitle information delivered from the subtitle analyzing unit 22 to identify a region relating to the contents of the subtitles from an item such as a place-name contained in the subtitle information, for example. The data representing the region identified by the related-region analyzing unit 25 is delivered to the related-map creating unit 26.

The related-map creating unit 26 reads from the map data memory 18 the map data corresponding to the data representing the region delivered from the related-region analyzing unit 25, and creates a subtitle-related map associated with the subtitle information. FIG. 10 shows an example of the subtitle-related map, in which roads corresponding to the subtitles “◯◯ automobile road (up)” are displayed emphatically. The data representing the subtitle-related map created by the related-map creating unit 26 is delivered to the video synthesizing unit 13.

Next, the operation of the digital broadcast receiver 200 of the embodiment 2 in accordance with the present invention with the foregoing configuration will be described centering on the operation at the time when receiving the subtitles while viewing a digital broadcast.

The radio waves of the digital broadcasting received by the antenna 1 are converted to an electric signal delivered to the tuner 2. The tuner 2 extracts the frequency component of the channel to be selected, which is designated by the CPU 17, from the signal delivered from the antenna 1, and delivers it to the OFDM demodulator 3. The OFDM demodulator 3 carries out OFDM demodulation of the signal delivered from the tuner 2 and then converts it to a digital signal, and delivers it to the demultiplexer 4 as a transport stream. The demultiplexer 4 separates the transport stream delivered from the OFDM demodulator 3 to the audio stream, video stream and carousel, and delivers them to the audio decoder 5, video decoder 10 and CPU 17, respectively.

The carousel separated by the demultiplexer 4 is delivered to the subtitle analyzing unit 22 of the CPU 17. The subtitle analyzing unit 22 performs the analysis and extraction of the subtitles contained in the carousel received from the demultiplexer 4 to generate the subtitle information. The subtitle information generated by the subtitle analyzing unit 22 is delivered to the graphics creating unit 23 and related-region analyzing unit 25.

The graphics creating unit 23 creates the subtitle presenting image from the subtitle information delivered from the subtitle analyzing unit 22, and delivers to the video synthesizing unit 13 as the subtitle presenting image data.

The related-region analyzing unit 25 analyzes the subtitle information delivered from the subtitle analyzing unit 22 to identify the region relating to the contents of the subtitles, and delivers the identified data representing the region to the related-map creating unit 26. The related-map creating unit 26 reads from the map data memory 18 the map data corresponding to the data representing the region delivered from the related-region analyzing unit 25, and creates the subtitle-related map associated with the subtitle information. The data representing the subtitle-related map created by the related-map creating unit 26 is delivered to the video synthesizing unit 13.

The video synthesizing unit 13 generates the output video data by combining the digital broadcast image delivered from the video decoder 10, the menu screen delivered from the GUI unit 12, the subtitle presenting image delivered from the graphics creating unit 23 and the subtitle-related map delivered from the related-map creating unit 26 in such a manner that they are arranged within the screen of the monitor 15, and delivers to the video control unit 14. The video control unit 14 converts the output video data delivered from the video synthesizing unit 13 to an analog video signal, and delivers to the monitor 15. The monitor 15 displays an image corresponding to the video signal delivered from the video control unit 14.

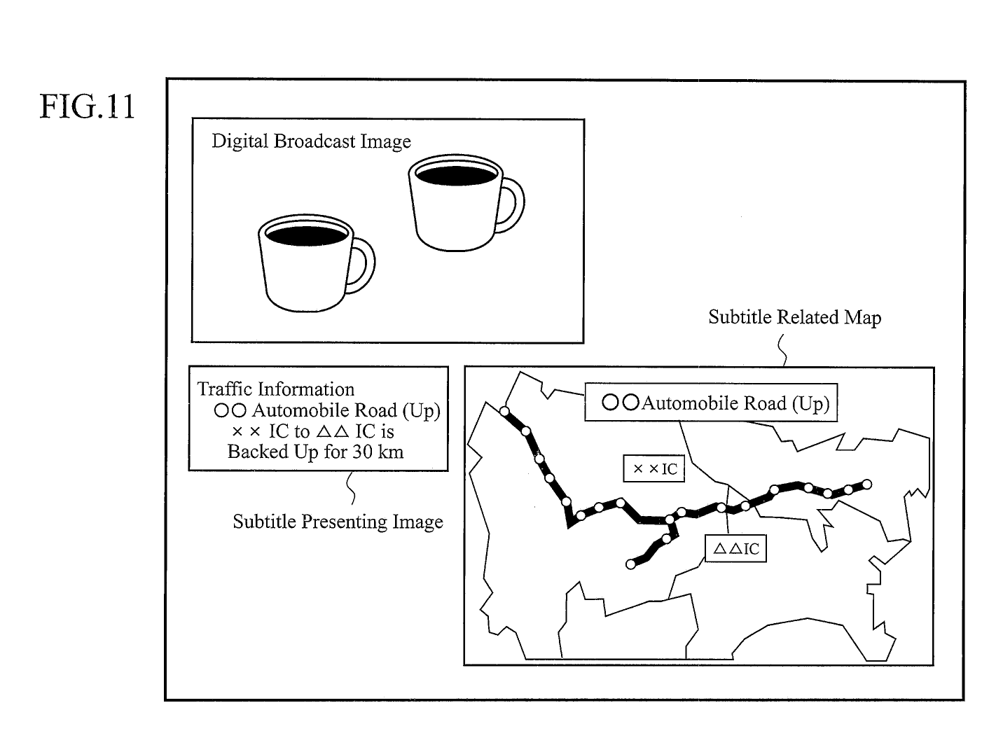

FIG. 11 is a diagram showing an example of the image displayed on the monitor 15 by the foregoing processing. The image is displayed in a fashion that the data broadcast image is reduced in the vertical and horizontal directions, and the subtitle presenting image and the subtitle-related map are arranged thereunder in such a manner as to avoid overlapping.

As described above, the digital broadcast receiver 200 of the embodiment 2 in accordance with the present invention can display the information on the received subtitles simultaneously with the digital broadcast image, and can inform the user of the region associated with the information on the subtitles more plainly.

Incidentally, when the subtitles contain an image, the video synthesizing unit 13 can be configured in such a manner as to carry out synthesis without the subtitle-related map.

In addition, a digital broadcast receiver of a second variation can be configured in such a manner that it has, in addition to the digital broadcast receiver of the first variation described above, an external image input unit 11 similar to that of the digital broadcast receiver 100 of the embodiment 1, that by introducing the function similar to that of the video layout unit 24 included in the CPU 17 of the digital broadcast receiver 100 of the embodiment 1, the subtitle analyzing unit 22 generates the subtitle information by analyzing the subtitles, and that the video synthesizing unit 13 combines the digital broadcast image created by the video decoder 10, the subtitle presenting image created by the graphics creating unit 23, and the car navigation image input from the subtitle-related map created by the related-map creating unit 26 in such a manner as to avoid overlaps between them by adjusting the display size and display position of each of them. According to the configuration, it can obtain the subtitles even during a time other than when viewing the digital broadcasting.

### Embodiment 3

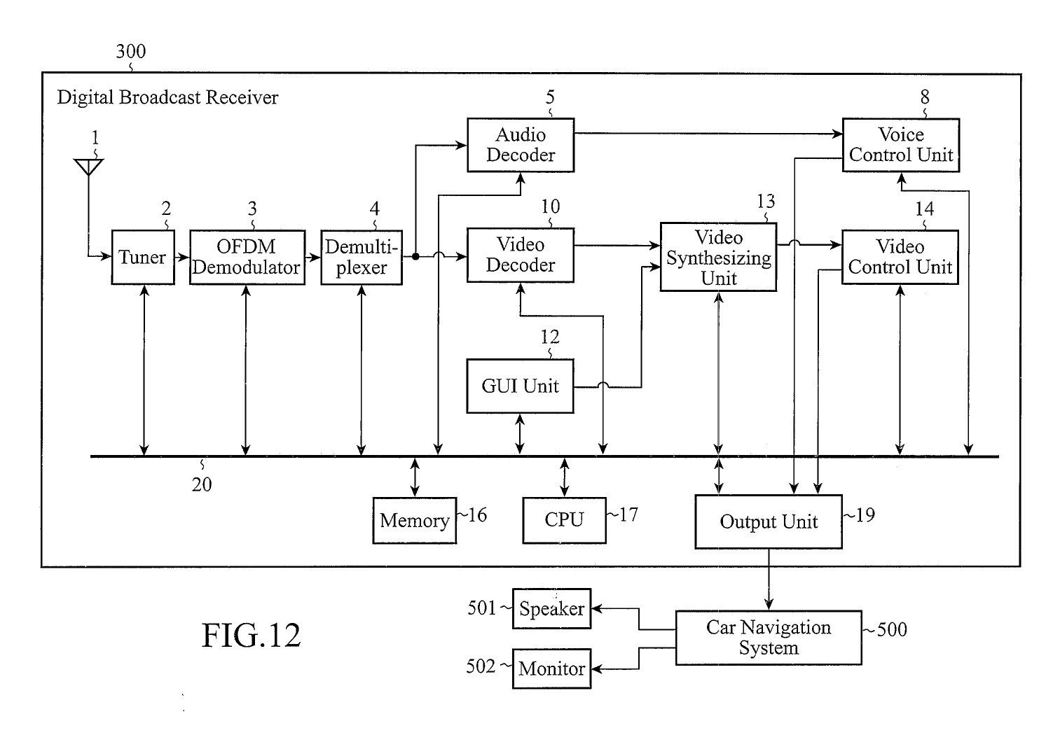

FIG. 12 is a block diagram showing a configuration of a digital broadcast receiver 300 of an embodiment 3 in accordance with the present invention. The digital broadcast receiver 300 is constructed by removing the speaker 9, monitor 15 and map data memory 18 from the digital broadcast receiver 200 of the embodiment 2, and by adding an output unit 19 thereto.

In the digital broadcast receiver 300, the voice signal output from the voice control unit 8, the video signal output from the video control unit 14 and the subtitle information output from the CPU 17 are delivered to the output unit 19. The output unit 19 delivers the voice signal, video signal and subtitle information to a car navigation system 500.

To the car navigation system 500, a speaker 501 and a monitor 502 are connected so that switching can be made between delivering the voice signal and video signal fed from the output unit 19 of the digital broadcast receiver 300 to the speaker 501 and monitor 502, respectively, and delivering the car navigation voice and car navigation image generated within itself to the speaker 501 and monitor 502, respectively.

In addition, the car navigation system 500 is configured in such a manner that it can create the subtitle presenting image from the subtitle information delivered from the output unit 19 of the digital broadcast receiver 300, combine the subtitle presenting image with the car navigation image generated inside itself, and deliver to the monitor 502.

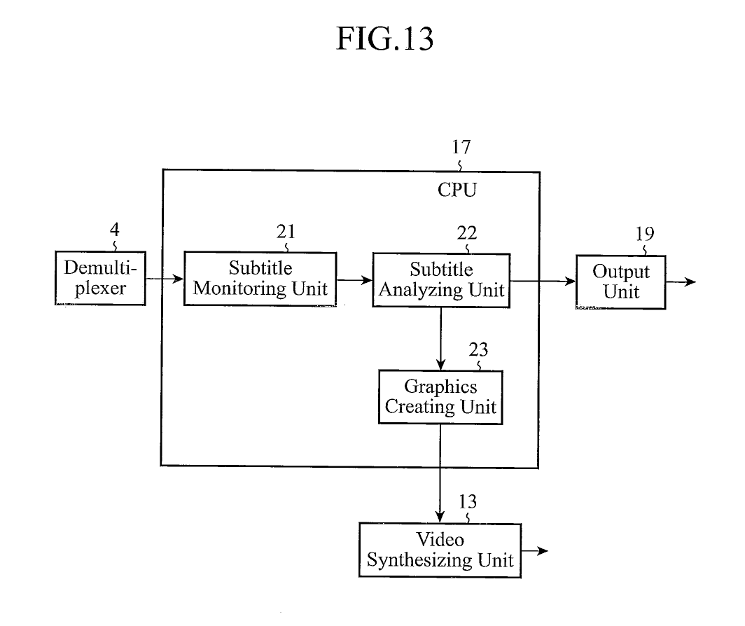

Next, details of the CPU 17 will be described. FIG. 13 is a block diagram showing a functional configuration of the CPU 17, which shows a portion only relating to the present invention. The CPU 17 includes a subtitle monitoring unit 21, a subtitle analyzing unit 22, and a graphics creating unit 23.

The subtitle monitoring unit 21 receives the carousel delivered from the demultiplexer 4, and monitors continuously (even during the time when the digital broadcasting is not viewed) as to whether the carousel contains the subtitles or not, that is, whether the subtitles are received or not. Then, when it detects any subtitles contained, it delivers the carousel containing the subtitles to the subtitle analyzing unit 22.

The subtitle analyzing unit 22 performs analysis and extraction of the subtitles contained in the carousel delivered from the subtitle monitoring unit 21 to generate the subtitle information as shown in FIG. 3, for example. The subtitle information generated by the subtitle analyzing unit 22 is delivered to the graphics creating unit 23 and output unit 19. Incidentally, when the subtitle presenting image is created in the car navigation system 500, the subtitle information created by the subtitle analyzing unit 22 is not delivered to the graphics creating unit 23.

The graphics creating unit 23 creates the subtitle presenting image as shown in FIG. 4, for example, from the subtitle information delivered from the subtitle analyzing unit 22. The subtitle presenting image data representing the subtitle presenting image created by the graphics creating unit 23 is delivered to the video synthesizing unit 13.

Next, the operation of the digital broadcast receiver 300 of the embodiment 3 in accordance with the present invention with the foregoing configuration will be described. In the operation of the digital broadcast receiver 300, the operation at the time of receiving the subtitles while viewing the digital broadcast is the same as that of the digital broadcast receiver 100 of the embodiment 1 except that the voice and images are output from the speaker 501 and monitor 502 connected to the car navigation system 500.

Next, the operation will be described in the case where the digital broadcast receiver 300 of the embodiment 3 receives the subtitles while viewing the car navigation image and listening to the car navigation voice generated by the car navigation system 500. In this case, although the car navigation image is displayed on the monitor 15, the processing such as receiving, demultiplexing and decoding of a digital broadcast is carried out in parallel in the background.

As for the operations of receiving the digital broadcasting with the antenna 1, of separating it into the audio stream, video stream and carousel by the demultiplexer 4, and of delivering to the audio decoder 5, video decoder 10 and CPU 17, respectively, they are the same as those when the foregoing digital broadcast receiver 100 of the embodiment 1 receives the subtitles while viewing the digital broadcasting.

The carousel separated by the demultiplexer 4 is delivered to the subtitle monitoring unit 21 of the CPU 17. The subtitle monitoring unit 21, which continuously monitors the presence or absence of the reception of the subtitles, delivers, when detecting the reception of the subtitles, the carousel containing the subtitles to the subtitle analyzing unit 22. The subtitle analyzing unit 22 performs the analysis and extraction of the subtitles contained in the carousel received from the subtitle monitoring unit 21 to generate the subtitle information. The subtitle information generated by the subtitle analyzing unit 22 is delivered to the output unit 19.

The output unit 19 delivers the subtitle information generated by the subtitle analyzing unit 22 to the car navigation system 500. The car navigation system 500 acquires the contents (text) of the subtitles to be displayed from the subtitle information delivered from the output unit 19 to create the subtitle presenting image. Then, the car navigation system 500 combines the subtitle presenting image created with the car navigation image generated within itself, and delivers to the monitor 502. Thus, an image consisting of the subtitles and the car navigation image such as a map generated within the car navigation system 500 itself is displayed on the monitor 502.

As described above, according to the digital broadcast receiver 300 of the embodiment 3 in accordance with the present invention, since it is configured in such a manner as to deliver the subtitle information to the car navigation system 500, it can cause the car navigation system 500 to display the subtitle presenting image. In addition, since it is configured in such a manner as to display the car navigation image and the subtitle presenting image after combining them, the user can obtain information about the subtitles without switching the screen.

Next, a variation of the digital broadcast receiver 300 of the foregoing embodiment 3 will be described. In the digital broadcast receiver of the first variation, as in the digital broadcast receiver 200 of the embodiment 2, the car navigation system 500 identifies the related region by detecting place-names such as ◯◯ automobile road, XX IC and ◯◯ IC from the subtitle information delivered from the output unit 19, and reads the map data on the related region identified from the map data memory (not shown) retained in itself to create the subtitle-related map.

In addition, the car navigation system 500 creates the subtitle presenting image from the subtitle information delivered from the output unit 19, and is configured in such a manner as to combine the subtitle-related map with the subtitle-related map and to display on the monitor 502. According to the digital broadcast receiver of the first variation, it can inform the user of the subtitle information and the related region plainly.

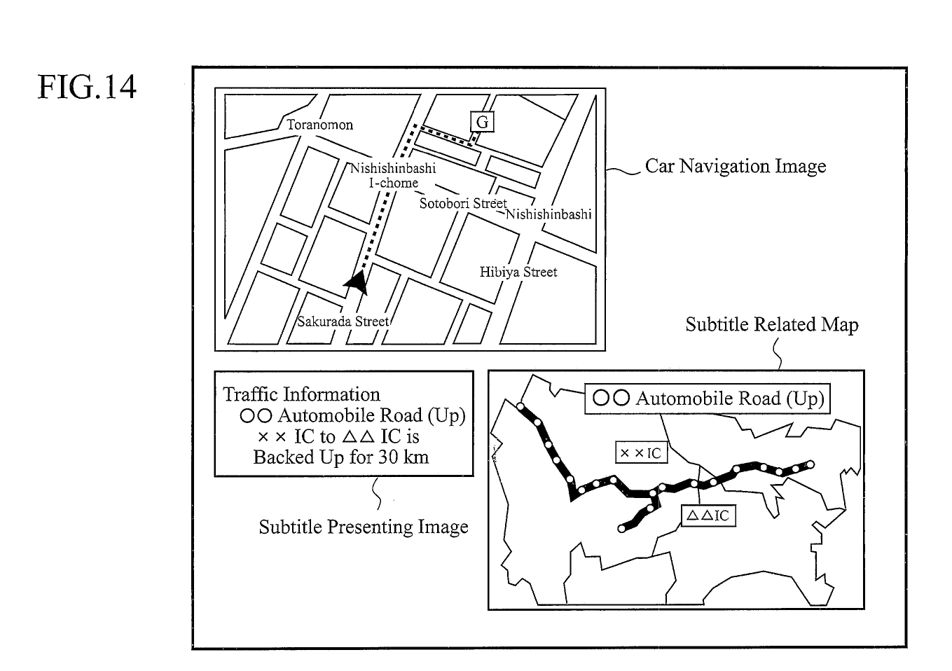

The digital broadcast receiver of a second variation introduces into the car navigation system 500 a function similar to that of the video layout unit 24 included in the CPU 17 of the digital broadcast receiver 100 of the embodiment 1, and combines the subtitle presenting image created from the subtitle information delivered from the output unit 19 with the car navigation image generated within itself in such a manner as to avoid overlaps between them by adjusting the display size and display position of each of them, and displays on the monitor 502. FIG. 14 is a diagram showing an example of an image displayed on the monitor 15 by the digital broadcast receiver of the second variation. The car navigation image is reduced in both the vertical and horizontal directions, and the subtitle presenting image and subtitle-related map are disposed and displayed under it in such a manner as to avoid overlaps. According to the configuration, it can prevent the display from being overlooked.

The digital broadcast receiver of a third variation introduces into the car navigation system 500 a function similar to that of the video layout unit 24 included in the CPU 17 of the digital broadcast receiver 100 of the embodiment 1, detects a related region by analyzing the subtitle information delivered from the output unit 19, creates a subtitle-related map about the detected related region, combines the created subtitle-related map and the subtitle presenting image created from the subtitle information delivered from the output unit 19 and decides the size and display position of each of them in such a manner as to avoid overlaps between them, and displays on the monitor 502. According to the configuration, it can prevent the display from being overlooked.

Incidentally, in the digital broadcast receivers of the foregoing embodiments 1-3 and in their variations, the monitor 15 or monitor 502 can be constructed in such a manner as to display after appropriately adjusting a character font of the subtitle presenting image created from the subtitle information. According to the configuration, it can improve the readability of the subtitles displayed on the monitor 15.

### INDUSTRIAL APPLICABILITY

As described above, the digital broadcast receiver in accordance with the present invention is configured in such a manner as to create a subtitle presenting image by acquiring subtitle information from a received signal obtained by receiving digital broadcasting in the background while displaying an external image, and to combine and display the external image and the subtitle presenting image in such a manner as to avoid overlaps between them. Accordingly, it can display subtitles without switching the image currently viewed to the digital broadcasting, and is suitable for a car navigation system and the like.

What is claimed is:

1. A digital broadcast receiver comprising:
receiving means for receiving a digital broadcast;
a subtitle monitoring unit for continuously monitoring as to whether a received signal from the receiving means contains subtitles or not;
a subtitle analyzing unit for analyzing, when the subtitle monitoring unit detects that the subtitles are contained, the subtitles to generate subtitle information;
an external image input unit for receiving an external image from outside;
a video layout unit for deciding, as to a subtitle presenting image generated from the subtitle information from the subtitle analyzing unit and the external image from the external image input unit, display size and display position of each of the subtitle presenting image and the external image in a manner as to avoid overlaps between them;
a graphics creating unit for creating from the subtitle information from the subtitle analyzing unit the subtitle presenting image with the display size and display position decided by the video layout unit;
a video synthesizing unit for combining the subtitle presenting image created by the graphics creating unit and the external image from the external image input unit; and
display means for displaying an image synthesized by the video synthesizing unit.

2. A digital broadcast receiver comprising:
receiving means for receiving a digital broadcast;
a video decoder for decoding a received signal from the receiving means to create a digital broadcast image;
a subtitle analyzing unit for analyzing subtitles contained in the received signal from the receiving means to generate subtitle information;
a map data memory that stores map data;
a related-region analyzing unit for analyzing the subtitle information from the subtitle analyzing unit to identify a related region;
a related-map creating unit for reading from the map data memory the map data about the related region identified by the related-region analyzing unit to create a subtitle-related map;
a graphics creating unit for creating a subtitle presenting image from the subtitle information from the subtitle analyzing unit;
a video synthesizing unit for combining the digital broadcast image created by the video decoder, the subtitle presenting image created by the graphics unit, and the subtitle-related map created by the related-map creating unit; and
display means for displaying an image synthesized by the video synthesizing unit.

3. A digital broadcast receiver comprising:
receiving means for receiving a digital broadcast;
a subtitle monitoring unit for continuously monitoring as to whether a received signal from the receiving means contains subtitles or not;
a subtitle analyzing unit for analyzing, when the subtitle monitoring unit detects that the subtitles are contained, the subtitles to generate subtitle information; and
an output unit for outputting the subtitle information from the subtitle analyzing unit to outside.

4. The digital broadcast receiver according to claim 3, further comprising:
external equipment for creating a subtitle presenting image from the subtitle information output from the output unit, for combining the created subtitle presenting image with an image generated within the external equipment, and for displaying a synthesized image.

5. The digital broadcast receiver according to claim 4, wherein
the external equipment analyzes the subtitle information delivered from the output unit to detect a related region, creates a subtitle-related map, a map about the related region detected, combines the created subtitle-related map and the subtitle presenting image created from the subtitle information delivered from the output unit, and displays a synthesized image.

6. The digital broadcast receiver according to claim 2, wherein
the video synthesizing unit combines the digital broadcast image created by the video decoder, the subtitle presenting image created by the graphics creating unit and the subtitle-related map created by the related-map creating unit in a manner as to avoid overlaps between them by adjusting display size and display position of each of them.

7. The digital broadcast receiver according to claim 2, further comprising:
an external image input unit for receiving an external image from outside, wherein
the video synthesizing unit combines the digital broadcast image created by the video decoder, the subtitle presenting image created by the graphics creating unit, the subtitle-related map created by the related-map creating unit, and the external image fed from the external image input unit in a manner as to avoid overlaps between them by adjusting display size and display position of each of them.

8. The digital broadcast receiver according to claim 4, wherein
the external equipment combines the subtitle presenting image created from the subtitle information delivered from the output unit and the image generated within the external equipment in a manner as to avoid overlaps between them by adjusting display size and display position of each of them.

9. The digital broadcast receiver according to claim 5, wherein
the external equipment identifies the related region by analyzing the subtitle information delivered from the output unit, creates the subtitle-related map about the related region identified, combines the subtitle-related map created and the subtitle presenting image created from the subtitle information from the output unit in a manner as to avoid overlaps between them by deciding display size and display position of each of them, and displays a synthesized image.

10. The digital broadcast receiver according to claim 1, wherein
a character font of the subtitle presenting image created from the subtitle information is adjusted at a time of display.

11. The digital broadcast receiver according to claim 2, wherein
a character font of the subtitle presenting image created from the subtitle information is adjusted at a time of display.

12. The digital broadcast receiver according to claim 3, wherein
a character font of the subtitle presenting image created from the subtitle information is adjusted at a time of display.
